(19) United States
(12) Patent Application Publication
(10) Pub. No.: US 2026/0188194 A1
(43) Pub. Date: Jul. 2, 2026

(54) LIGHT EMITTING DISPLAY APPARATUS AND PIXEL CIRCUIT

(71) Applicant: LG Display Co., Ltd., Seoul (KR)

(72) Inventors: JaeHee PARK, Paju-si (KR); Sunghee PARK, Paju-si (KR)

(73) Assignee: LG Display Co., Ltd., Seoul (KR)

(21) Appl. No.: 19/392,661

(22) Filed: Nov. 18, 2025

(30) Foreign Application Priority Data
Dec. 26, 2024 (KR) 10-2024-0197613

(51) Int. Cl. G09G 3/32

(52) U.S. Cl. CPC G09G 3/32; G09G 2300/043; G09G 2300/0465; G09G 2300/0819; G09G 2310/0267; G09G 2310/0275; G09G 2310/08

(57) ABSTRACT

A light emitting display apparatus according to one or more embodiments of the present disclosure may include a display panel including a plurality of subpixels connected to data lines, gate lines, and driving voltage lines, a data driving circuit configured to supply data signals to the data lines, and a gate driving circuit configured to supply scan signals to the gate lines, each of the plurality of subpixels may include a light emitting device, a driving transistor configured to connect between the driving voltage line and the light emitting device, and to control a current flowing through the light emitting device, a first switching transistor configured to connect between a first node of the driving transistor and the data line, a second switching transistor configured to connect between a second node of the driving transistor, which is connected to the light emitting device, and the data line, a first capacitor connected between the first node and the second node, and a second capacitor connected between a third node of the driving transistor, which is connected to the driving voltage line, and the second node.

### CROSS-REFERENCE TO RELATED APPLICATIONS

This application claims the benefit of and priority to Korean Patent Application No. 10-2024-0197613 filed in Republic of Korea on Dec. 26, 2024, the entirety of which is incorporated herein by reference for all purposes.

### BACKGROUND

### Technical Field

The present disclosure relates to a light emitting display apparatus and a pixel circuit.

### Description of the Related Art

With the development of the information society, the demand for a display apparatus for displaying an image is increasing in various forms, and light emitting display apparatuses such as a liquid crystal display (LCD), an organic light emitting display (OLED), a micro light emitting diode display (Micro LED display), and a quantum dot display (QD) are being utilized.

A light emitting display apparatus arranges a plurality of pixels including light emitting devices in a matrix form and controls the luminance of the pixels according to a gradation of image data. Each of the pixels includes a driving transistor for controlling a driving current flowing through the light emitting device according to a gate-source voltage (Vgs), and one or more switching transistors for programming the gate-source voltage of the driving transistor. The gradation (or luminance) is controlled based on an emission amount of the light emitting device that is proportional to the driving current.

However, due to various causes including process variations, there may be deviations in the driving characteristics among the pixels. In addition, depending on the driving time of the light emitting display apparatus, the degradation progresses at different rates among the pixels, which may further increase differences in the driving characteristics. Therefore, the amount of the driving current flowing through the light emitting device varies depending on the deviation in the driving characteristics among the pixels, resulting in non-uniformity of image quality.

### BRIEF SUMMARY

A light emitting display apparatus includes a compensation circuit for compensating for a deviation in the driving characteristics of a driving transistor. The compensation circuit is applied within a pixel and is configured to sample or sense a gate-source voltage of the driving transistor, and to compensate for the driving characteristics of the driving transistor based on the sensed value. However, the compensation circuit requires a separate reference voltage line (or sensing voltage line) to initialize or sense the gate-source voltage of the driving transistor, which results in a reduction in the aperture ratio of the display panel.

One or more embodiments of the present disclosure may provide a light emitting display apparatus capable of simplifying a pixel circuit and voltage lines and improving an aperture ratio of a light emitting portion or transparency of a transmissive area, by initializing a driving transistor using a data signal through a data line without requiring a reference voltage line.

One or more embodiments of the present disclosure may provide a light emitting display apparatus capable of simplifying a pixel circuit and voltage lines while reducing a loss of data transmission ratio and compensating for variations in driving characteristics of a driving transistor.

Additional characteristics and features of the disclosure will be set forth in part in the description which follows and in part will become apparent to those having ordinary skill in the art upon examination of the following or may be learned from practice of the disclosure. The features and characteristics of the disclosure may be realized and attained by the structure particularly pointed out in the written description and claims hereof as well as the appended drawings.

A light emitting display apparatus according to one or more embodiments of the present disclosure may include a display panel including a plurality of subpixels connected to data lines, gate lines, and driving voltage lines, a data driving circuit configured to supply data signals to the data lines, and a gate driving circuit configured to supply scan signals to the gate lines, each of the plurality of subpixels may include a light emitting device, a driving transistor configured to connect between the driving voltage line and the light emitting device, and to control a current flowing through the light emitting device, a first switching transistor configured to connect between a first node of the driving transistor and the data line, a second switching transistor configured to connect between a second node of the driving transistor, which is connected to the light emitting device, and the data line, a first capacitor connected between the first node and the second node, and a second capacitor connected between a third node of the driving transistor, which is connected to the driving voltage line, and the second node.

A light emitting display apparatus according to one or more embodiments of the present disclosure may include a display panel including a plurality of subpixels connected to data lines, gate lines, and driving voltage lines; wherein the plurality of subpixels includes at least one first subpixel arranged along a first direction and a plurality of second subpixels arranged along a second direction intersecting the first direction, wherein each of the plurality of subpixels comprises a light emitting device and a subpixel circuit configured to drive the light emitting device, wherein the subpixel circuit of the at least one first subpixel arranged along the first direction comprises: a driving transistor configured to connect between the driving voltage line and the light emitting device, and to control a current flowing through the light emitting device, a first switching transistor configured to connect between a first node of the driving transistor and the data line, a second switching transistor configured to connect between a second node of the driving transistor, which is connected to the light emitting device, and the data line, a first capacitor connected between the first node and the second node, and wherein the subpixel circuit of each of the plurality of second subpixels arranged along the second direction comprises the driving transistor, the first switching transistor, the second switching transistor, the first capacitor, and a second capacitor connected between a third node of the driving transistor, which is connected to the driving voltage line, and the second node.

A pixel circuit according to one or more embodiments of the present disclosure may be configured to drive a light emitting device, and may include a driving transistor configured to connect between a driving voltage line and the light emitting device, and to control a current flowing through the light emitting device, a first switching transistor configured to connect between a first node of the driving transistor and a data line, a second switching transistor configured to connect between a second node of the driving transistor, which is connected to the light emitting device, and the data line, a first capacitor connected between the first node and the second node, and a second capacitor connected between a third node of the driving transistor, which is connected to the driving voltage line, and the second node.

According to one or more embodiments of the present disclosure, a light emitting display apparatus capable of simplifying a pixel circuit and voltage lines and improving an aperture ratio of a light emitting portion or transparency of a transmissive area, by initializing a driving transistor using a data signal through a data line without requiring a reference voltage line, may be provided.

According to one or more embodiments of the present disclosure, a light emitting display apparatus capable of simplifying a pixel circuit and voltage lines while reducing a loss of data transmission ratio and compensating for variations in driving characteristics of a driving transistor, may be provided.

The light emitting display apparatus according to one or more embodiments of the present disclosure may improve an aperture ratio of a light emitting portion or transparency of a transmissive area by simplifying a pixel circuit and voltage lines, reduce a loss in data transmission ratio, and compensate for variations in driving characteristics of a driving transistor. Accordingly, it is possible to reduce the cost of the light emitting display apparatus, improve the reliability and display quality thereof, and reduce production energy, whereby it is possible to implement Environment/Social/Governance (ESG).

The effects of the present disclosure are not limited to the aforesaid, but other effects not described herein will be clearly understood by those skilled in the art from the following descriptions.

The details of the present disclosure described in technical problem, technical solution, and advantageous effects do not specify essential features of claims, and thus, the scope of claims is not limited by the details described in detailed description of the disclosure.

### BRIEF DESCRIPTION OF THE SEVERAL VIEWS OF THE DRAWINGS

The accompanying drawings, which are included to provide a further understanding of the disclosure, are incorporated in and constitute a part of this disclosure, illustrate aspects and embodiments of the disclosure, and together with the description serve to explain the principles and examples of the disclosure.

FIG. 1 illustrates a schematic configuration of a display apparatus according to an embodiment of the present disclosure.

FIG. 2 illustrates a circuit configuration of a subpixel according to one embodiment of the present disclosure.

FIG. 3 illustrates a driving timing of a subpixel according to one embodiment of the present disclosure.

FIG. 4 illustrates an operation state of a pixel circuit in a first period of the subpixel shown in FIG. 3, according to one embodiment of the present disclosure.

FIG. 5 illustrates voltage changes of nodes in the pixel circuit shown in FIG. 4, according to one embodiment of the present disclosure.

FIG. 6 illustrates an operation state of a pixel circuit in a second period of the subpixel shown in FIG. 3, according to one embodiment of the present disclosure.

FIG. 7 illustrates voltage changes of nodes in the pixel circuit shown in FIG. 6, according to one embodiment of the present disclosure.

FIG. 8 illustrates an operation state of a pixel circuit in a third period of the subpixel shown in FIG. 3, according to one embodiment of the present disclosure.

FIG. 9 illustrates voltage changes of nodes in the pixel circuit shown in FIG. 8, according to one embodiment of the present disclosure.

FIG. 10 illustrates voltage changes of nodes in the pixel circuit according to another embodiment of the present disclosure.

FIG. 11 illustrates voltage changes of nodes in the pixel circuit according to another embodiment of the present disclosure.

FIG. 12 illustrates a layout of a plurality of subpixels in a display panel according to another embodiment of the present disclosure.

FIG. 13 is a cross-sectional view taken along line I-I′ shown in FIG. 12, according to another embodiment of the present disclosure.

FIG. 14 illustrates a layout of a plurality of subpixels in a display panel according to another embodiment of the present disclosure.

FIG. 15 is a cross-sectional view taken along line II-II′ shown in FIG. 14, according to another embodiment of the present disclosure.

FIG. 16 illustrates a layout of a plurality of subpixels in a display panel according to another embodiment of the present disclosure.

FIG. 17 is a cross-sectional view taken along line III-III′ shown in FIG. 16, according to another embodiment of the present disclosure.

Throughout the drawings and the detailed description, unless otherwise described, the same drawing reference numerals should be understood to refer to the same elements, features, and structures. The sizes, lengths, and thicknesses of layers, regions and elements, and depiction of thereof may be exaggerated for clarity, illustration, and/or convenience.

### DETAILED DESCRIPTION

Advantages and features of the present disclosure, and implementation methods thereof, are clarified through the embodiments described with reference to the accompanying drawings. The present disclosure may, however, be embodied in different forms and should not be construed as limited to the embodiments set forth herein. Rather, these embodiments are examples and are provided so that this disclosure may be thorough and complete, to assist those skilled in the art to understand the inventive concepts without limiting the protected scope of the present disclosure.

Shapes (e.g., sizes, lengths, widths, heights, thicknesses, locations, radii, diameters, and areas), sizes, ratios, angles, numbers, and the like disclosed herein, including those illustrated in the drawings are merely examples, and thus, the present disclosure is not limited to the illustrated details. Any implementation described herein as an “example” is not necessarily to be construed as preferred or advantageous over other implementations. It is, however, noted that the relative dimensions of the components illustrated in the drawings are part of the present disclosure.

When the term “comprise,” “have,” “include,” “contain,” “constitute,” “made of,” “formed of,” or the like is used with respect to one or more elements, one or more other elements may be added unless a term such as “only” or the like is used. The terms used in the present disclosure are merely used in order to describe example embodiments, and are not intended to limit the scope of the present disclosure. The terms of a singular form may include plural forms unless the context clearly indicates otherwise.

In construing an element, the element is construed as including an error region although there is no explicit description thereof.

In describing a positional relationship, for example, when the positional order is described as “on,” “above,” “below,” “beneath,” and “next,” the case of no contact therebetween may be included, unless “just” or “direct” is used.

If it is mentioned that a first element is positioned “on” a second element, it does not mean that the first element is essentially positioned above the second element in the figure. The upper part and the lower part of an object concerned may be changed depending on the orientation of the object. Consequently, the case in which a first element is positioned “on” a second element includes the case in which the first element is positioned “below” the second element as well as the case in which the first element is positioned “above” the second element in the figure or in an actual configuration.

In describing a temporal relationship, for example, when the temporal order is described as “after,” “subsequent,” “next,” and “before,” a case which is not continuous may be included, unless “just” or “direct” is used.

It will be understood that, although the terms “first,” “second,” etc., may be used herein to describe various elements, these elements should not be limited by these terms. These terms are only used to distinguish one element from another. For example, a first element could be termed a second element, and, similarly, a second element could be termed a first element.

In describing elements of the present disclosure, the terms “first,” “second,” “A,” “B,” “(a),” “(b),” or the like may be used. These terms are intended to identify the corresponding element(s) from the other element(s), and these are not used to define the essence, basis, order, or number of the elements.

For the expression that an element is “connected,” “coupled,” “attached,” “adhered,” or the like to another element, the element may not only be directly connected, coupled, attached, adhered, or the like to another element, but also be indirectly connected, coupled, attached, adhered, or the like to another element with one or more intervening elements disposed or interposed between the elements, unless otherwise specified.

For example, the phrase “A is connected to B” encompasses both a direct connection—where no intervening components or elements are present—and an indirect connection, where one or more intermediate components or elements exist between A and B. In other words, “A is connected to B” includes both direct physical or electrical coupling and indirect coupling through one or more intervening components. Unless explicitly stated otherwise, these terms do not require direct physical or electrical contact. The term “coupled” and other terms listed above should be interpreted in the same manner.

For the expression that an element is “contacts,” “overlaps,” or the like with another element, the element may not only directly contact, overlap, or the like with another element, but also indirectly contact, overlap, or the like with another element with one or more intervening elements disposed or interposed between the elements, unless otherwise specified.

The term “at least one” should be understood as including any and all combinations of one or more of the associated listed items. For example, “at least one among a first element, a second element and a third element” may include all combinations of two or more elements selected from the first, second and third elements as well as each element of the first, second and third elements.

Features of various embodiments of the present disclosure may be partially or entirety coupled to or combined with each other, may be technically associated with each other, and may be variously inter-operated, linked or driven together. The embodiments of the present disclosure may be implemented or carried out independently of each other, or may be implemented or carried out together in a co-dependent or related relationship. In one or more aspects, the components of each apparatus according to various embodiments of the present disclosure are operatively coupled and configured.

In the following description, various example embodiments of the present disclosure are described in detail with reference to the accompanying drawings. With respect to reference numerals to elements of each of the drawings, the same elements may be illustrated in other drawings, and like reference numerals may refer to like elements unless stated otherwise. The same or similar elements may be denoted by the same reference numerals even though they are depicted in different drawings. In addition, for convenience of description, a scale, dimension, size, and thickness of each of the elements illustrated in the accompanying drawings may be different from an actual scale, dimension, size, and thickness, and thus, embodiments of the present disclosure are not limited to a scale, dimension, size, and thickness illustrated in the drawings.

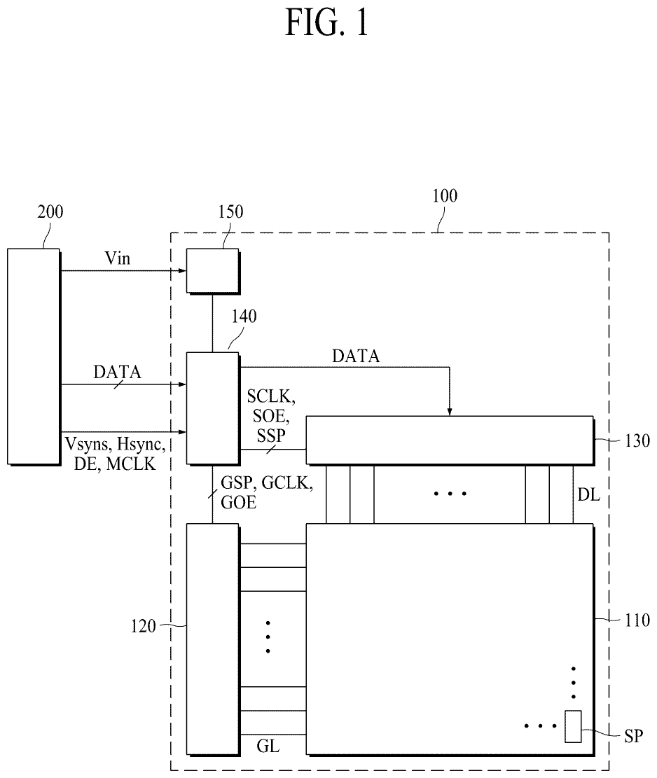

FIG. 1 illustrates a schematic configuration of a display apparatus according to an embodiment of the present disclosure.

Referring to FIG. 1, a light emitting display apparatus 100 according to an embodiment of the present disclosure may include a display panel 110 in which a plurality of subpixels SP are arranged in a matrix form and a plurality of gate lines GL and data lines DL are connected, a gate driving circuit 120 configured to drive the plurality of gate lines GL, a data driving circuit 130 configured to drive the plurality of data lines DL, a timing controller 140 configured to control the gate driving circuit 120 and the data driving circuit 130, and a power management IC (PMIC) 150.

The display panel 110 may display an image based on a scan signal transmitted from the gate driving circuit 120 through the plurality of gate lines GL and a data signal transmitted from the data driving circuit 130 through the plurality of data lines DL.

The display panel 110 may include a plurality of pixels arranged in a matrix form, and each pixel may include subpixels SP of different colors. For example, the plurality of subpixels SP may include a red subpixel, a green subpixel, a blue subpixel, and a white subpixel. Each subpixel SP may be defined by the plurality of data lines DL and the plurality of gate lines GL.

Each pixel may include four subpixels SP of red, green, blue, and white. When the resolution of the display panel 110 is configured as 2,160×3,840, a total of 15,360 data lines DL may be included by providing 3,840 data lines DL for each of the four subpixels SP and 2,160 gate lines GL. Each subpixel SP may be disposed at an intersection of the gate lines GL and the data lines DL.

The gate driving circuit 120 is controlled by the timing controller 140 and may control a driving timing of the plurality of subpixels SP by sequentially outputting scan signals to the plurality of gate lines GL disposed in the display panel 110.

The gate driving circuit 120 may be located on one side or both sides of the display panel 110 depending on a driving method of the display panel 110. For example, the gate driving circuit 120 may be implemented in a bezel region of the display panel 110 by a GIP (Gate driver In Panel) method or a TAB (Tape Automated Bonding) method, but embodiments of the present disclosure are not limited thereto.

The data driving circuit 130 may receive image data DATA from the timing controller 140 and convert the received image data DATA into an analog data signal (or data voltage). The data driving circuit 130 outputs data signals to respective data lines DL in synchronization with a timing at which scan signals are applied through gate lines GL, so that each subpixel SP connected to the data lines DL may display a light-emission signal having brightness corresponding to the data signals. According to an embodiment of the present disclosure, the data driving circuit 130 may include a first data signal having an initialization voltage and a second data signal having a data voltage. For example, the data driving circuit 130 may supply a first data signal having an initialization voltage to the data lines DL during an initialization period of each pixel, and may supply a second data signal having a data voltage to the data lines DL during a data programming period of each pixel.

The data driving circuit 130 may include one or more source driving integrated circuits SDICs. The source driving integrated circuit SDIC may be connected to bonding pads of the display panel 110 by a TAB (Tape Automated Bonding) method or a COF (Chip On Film) method, or may be directly disposed on the display panel 110, but embodiments of the present disclosure are not limited thereto.

The timing controller 140 may supply various control signals to the gate driving circuit 120 and the data driving circuit 130 and may control operations of the gate driving circuit 120 and the data driving circuit 130. For example, the timing controller 140 may control the gate driving circuit 120 to output scan signals according to timing implemented in each frame, and may deliver digital image data DATA received from an external source to the data driving circuit 130.

The timing controller 140 may receive various timing signals including image data DATA, a vertical synchronization signal Vsync, a horizontal synchronization signal Hsync, a data enable signal DE, and a main clock MCLK from an external host system 200. For example, the host system 200 may be at least one of a television TV system, a set-top box, a navigation system, a personal computer PC, a home theater system, a mobile device, and a wearable device, but embodiments of the present disclosure are not limited thereto.

The timing controller 140 may generate control signals using various timing signals received from the host system 200, and may deliver the control signals to the gate driving circuit 120 and the data driving circuit 130.

The timing controller 140 may output various gate control signals to control the gate driving circuit 120, including a gate start pulse GSP, a gate clock GCLK, and a gate output enable signal GOE. For example, the gate start pulse GSP may control timing at which the gate driving circuit 120 starts operation. The gate clock GCLK is a clock signal commonly input to the gate driving circuit 120 and may control the shift timing of the scan signals. The gate output enable signal GOE may control the output timing of the gate driving circuit 120.

The timing controller 140 may output various data control signals to control the data driving circuit 130, including a source start pulse SSP, a source sampling clock SCLK, and a source output enable signal SOE. For example, the source start pulse SSP may control timing at which the data driving circuit 130 starts data sampling. The source sampling clock SCLK may be a clock signal that controls timing for sampling data in the data driving circuit 130. The source output enable signal SOE may control output timing of the data driving circuit 130.

The light emitting display apparatus 100 according to an embodiment of the present disclosure may include a power management circuit 150 configured to supply various voltages or currents to the display panel 110, the gate driving circuit 120, and the data driving circuit 130, or to control the supply of various voltages or currents thereto.

The power management circuit 150 may generate power necessary for driving the display panel 110, the gate driving circuit 120, and the data driving circuit 130 by adjusting a direct current input voltage Vin supplied from the host system 200.

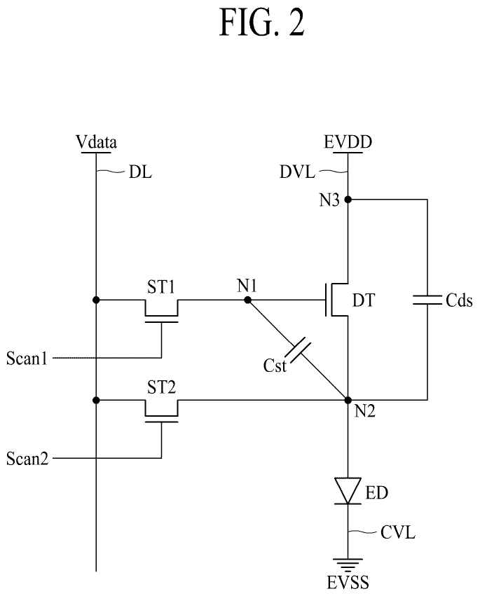

FIG. 2 illustrates a circuit configuration of a subpixel according to one embodiment of the present disclosure.

Referring to FIG. 2, the light emitting display apparatus according to one embodiment of the present disclosure includes a plurality of subpixels SP comprising a unit pixel, and each of the plurality of subpixels SP may include a pixel circuit including a driving transistor DT, a first switching transistor ST1, a second switching transistor ST2, a first capacitor Cst, and a second capacitor Cds, and a light emitting device ED.

At least one transistor DT, ST1 and ST2 included in the pixel circuit may be a three-electrode device including a gate, a source, and a drain. The source electrode and the drain electrode are not fixed and may change depending on the voltage applied to the gate electrode and the direction of current. Accordingly, any one of the source electrode and the drain electrode may be referred to as a first electrode, and the other as a second electrode. At least one transistor DT, ST1 and ST2 may be implemented as an oxide thin film transistor including an oxide semiconductor, a low temperature poly silicon LTPS TFT including low temperature poly silicon, or the like. Also, at least one transistor DT, ST1 and ST2 may be a P-type or an N-type transistor, or a combination of P-type and N-type transistors, but embodiments of the present disclosure are not limited thereto.

The at least one transistor DT, ST1 and ST2 may be controlled to be turned ON state or OFF state by a scan signal (or gate signal) applied to the gate electrode. The scan signal may swing between a gate on voltage and a gate off voltage. The gate on voltage is set higher than a threshold voltage of at least one transistor DT, ST1 and ST2, and the gate off voltage is set lower than the threshold voltage of the at least one transistor DT, ST1 and ST2. The at least one transistor DT, ST1 and ST2 may be turned ON in response to the gate on voltage or turned OFF in response to the gate off voltage. For example, in the case of an N-type transistor, the gate on voltage may be a gate high voltage VGH, and the gate off voltage may be a gate low voltage VGL. In the case of a P-type transistor, the gate on voltage may be the gate low voltage VGL, and the gate off voltage may be the gate high voltage VGH.

The light emitting device ED may include a pixel electrode (a first electrode or an anode electrode) connected to the pixel circuit, a common electrode (a second electrode or a cathode electrode) connected to a common voltage line CVL, and an emission layer between the pixel electrode and the common electrode. The pixel electrode may be an independent electrode for each light emitting device, and the common electrode may be a shared electrode for all the light emitting devices. The light emitting device ED may generate light having a predetermined luminance corresponding to an amount of current supplied from the pixel circuit.

The driving transistor DT may be connected between a driving voltage line DVL (a first power voltage line) and the light emitting device ED. The driving transistor DT is a driving element that controls a current flowing through the light emitting device ED according to a gate-source voltage Vgs, and may include a first node N1 (or gate node) to which a data signal Vdata is applied, a second node N2 (or source node) connected to a pixel electrode of the light emitting device ED, and a third node N3 (or drain node) connected to the driving voltage line DVL and supplied with a driving power voltage EVDD (or first power voltage).

The first switching transistor ST1 may be connected between the first node N1 of the driving transistor DT and a data line DL. The first switching transistor ST1 may connect the data line DL to the first node N1. For example, the first switching transistor ST1 may be turned on by a first scan signal Scan1 and supply the data signal Vdata applied through the data line DL to the first node N1, which is a gate electrode of the driving transistor DT.

The second switching transistor ST2 may be connected between the second node N2 of the driving transistor DT and the data line DL. The second switching transistor ST2 may connect the data line DL to the second node N2. For example, the second switching transistor ST2 may be turned on by a second scan signal Scan2 and supply the data signal Vdata applied through the data line DL to the second node N2, which is a source electrode of the driving transistor DT.

The first capacitor Cst may be connected between the first node N1 and the second node N2 of the driving transistor DT. The first capacitor Cst may be a storage capacitor that maintains a voltage of the data signal Vdata supplied to the driving transistor DT during one frame. The first capacitor Cst may maintain a voltage difference between the first node N1 and the second node N2 of the driving transistor DT at a constant level. For example, the first capacitor Cst may store the voltage of the data signal Vdata supplied through the first switching transistor ST1, and may turn on the driving transistor DT using the stored voltage.

The second capacitor Cds may be connected between the third node N3 and the second node N2 of the driving transistor DT. The second capacitor Cds may serve to compensate a voltage of the second node N2 of the driving transistor DT. The second capacitor Cds may be configured to limit a voltage increase at the second node N2 during a programming operation of a data voltage, so that the gate-source voltage Vgs of the driving transistor DT has an appropriate level. The voltage of the second node N2 may correspond to a capacitance of the second capacitor Cds. For example, the voltage of the second node N2 may be determined in proportion to a capacitance of the second capacitor Cds. Also, the second node N2 may be electrically floated as the second switching transistor ST2 is turned off, and may reflect an electrical characteristic of the driving transistor DT based on the second capacitor Cds. For example, the electrical characteristic of driving transistor DT may include a threshold voltage or mobility of driving transistor DT.

The light emitting display apparatus according to one embodiment of the present disclosure may exclude a reference voltage line from the second node N2 of driving transistor DT, and may be configured to initialize the first node N1 and the second node N2 of driving transistor DT by using the data signal Vdata through the data line DL. Accordingly, the light emitting display apparatus may, during the programming operation of the data voltage, when the first switching transistor ST1 is turned on and the second switching transistor ST2 is turned off, cause the second node N2 to be electrically floated, and the voltage of the second node N2 may rise due to the data voltage at the first node N1, thereby causing the gate-source voltage Vgs of the driving transistor DT to decrease. For example, a decrease in the gate-source voltage Vgs of the driving transistor DT may reduce data transmission ratio, which may cause problems such as shortening of an emission time and lowering of luminance of the light emitting device. For example, the data transmission ratio may refer to a ratio of the gate-source voltage Vgs based on a difference between a data voltage and an initialization voltage.

The second capacitor Cds according to one embodiment of the present disclosure, may limit a voltage increase at the second node N2 during the programming operation of the data voltage, thereby maintaining the gate-source voltage Vgs of the driving transistor DT at an appropriate level. As a result, the electrical characteristic of the driving transistor DT may be reflected at the second node N2, and sampling of the threshold voltage of the driving transistor DT and programming of the data voltage may be performed simultaneously.

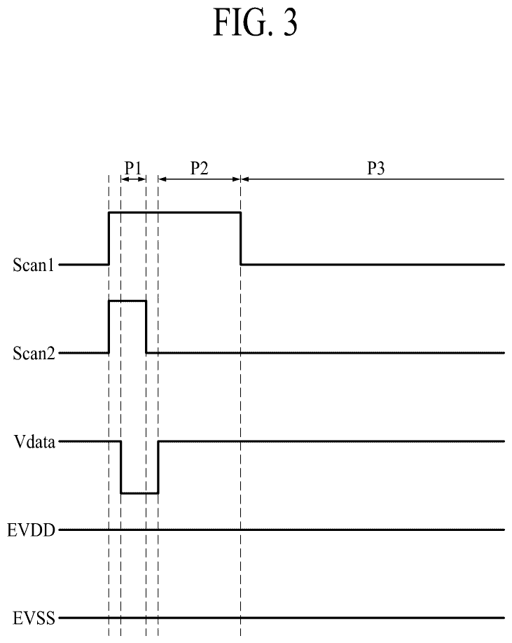

FIG. 3 illustrates a driving timing of a subpixel according to one embodiment of the present disclosure.

Referring to FIG. 3, each of a plurality of subpixels SP according to one embodiment of the present disclosure may be driven according to a first period P1, a second period P2, and a third period P3.

Each subpixel SP may receive a driving power voltage EVDD, a common power voltage EVSS, a data signal Vdata having an initialization voltage and a data voltage, a first scan signal Scan1, and a second scan signal Scan2.

The first scan signal Scan1 may be a signal for controlling the first switching transistor ST1, and the second scan signal Scan2 may be a signal for controlling the second switching transistor ST2. The first and second scan signals Scan1 and Scan2 may be supplied from the gate driving circuit 120. For example, the first and second scan signals Scan1 and Scan2 may have a gate on voltage or a gate off voltage at predetermined time intervals. For example, the gate on voltage may be a gate high voltage of 24V that turns on a transistor, and the gate off voltage may be a gate low voltage of −6V that turns off a transistor, but the embodiments of the present disclosure are not limited thereto.

The data signal Vdata may include a first data signal having an initialization voltage (or a reference voltage) and a second data signal having a data voltage. For example, the initialization voltage of the first data signal may be a voltage for initializing the first node N1 and the second node N2 of driving transistor DT, and may be 0V, but embodiments of the present disclosure are not limited thereto. Also, the data voltage of the second data signal may be a voltage supplied to the first node N1 of driving transistor DT to cause the light emitting device ED to emit light at a predetermined luminance, and may be higher than the initialization voltage.

The driving power voltage EVDD may be a high potential voltage and may be 24V, and the common power voltage EVSS may be a low potential voltage lower than the driving power voltage EVDD and may be 0V, but embodiments of the present disclosure are not limited thereto.

The first period P1 may be an initialization period for initializing the first node N1 and the second node N2 of driving transistor DT. In the first period P1, the first scan signal Scan1 and the second scan signal Scan2 may have the gate on voltage, and the data signal Vdata may be the first data signal having the initialization voltage. For example, the first period P1 may start at a time point when the first data signal (or the initialization voltage) is supplied, may overlap with an on-state of the first and second scan signals Scan1 and Scan2, and may end at a time point when the second scan signal Scan2 is switched to an off-state. For example, the first and second scan signals Scan1 and Scan2 may be switched to the on-state before the first period P1, but embodiments of the present disclosure are not limited thereto.

The second period P2 may be a data programming period for programming the data voltage into the pixel circuit. Also, in the second period P2, data programming and sampling of an electrical characteristic of driving transistor DT may be performed simultaneously. In the second period P2, the first scan signal Scan1 may maintain the gate on voltage, the second scan signal Scan2 may have the gate off voltage, and the data signal Vdata may be the second data signal having the data voltage. For example, the second period P2 may start at a time point when the second data signal (or the data voltage) is supplied, may overlap with an on-state of the first scan signal Scan1, and may end at a time point when the first scan signal Scan1 is switched to an off-state. For example, the second scan signal Scan2 may be switched to the off-state before the second period P2, but embodiments of the present disclosure are not limited thereto.

The third period P3 may be a light emission period for driving the light emitting device ED to emit light. In the third period P3, the first and second scan signals Scan1 and Scan2 may maintain the gate off voltage, and the data signal Vdata may be the second data signal having the data voltage. For example, the third period P3 may start at a time point when the first scan signal Scan1 is switched to an off-state, may continue while the second data signal (or the data voltage) is maintained, and may end at a time point when the first and second scan signals Scan1 and Scan2 are switched to an on-state.

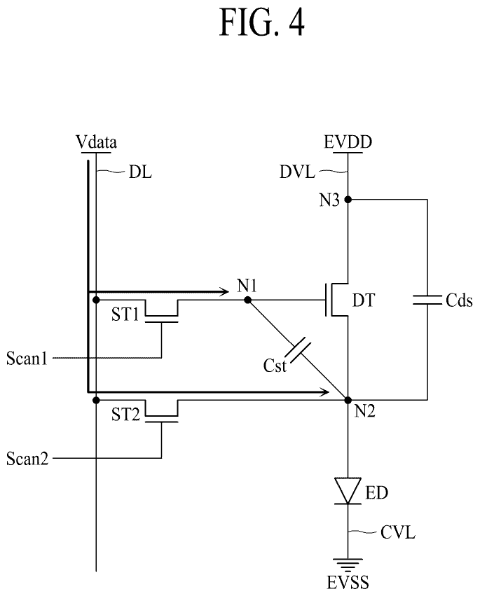

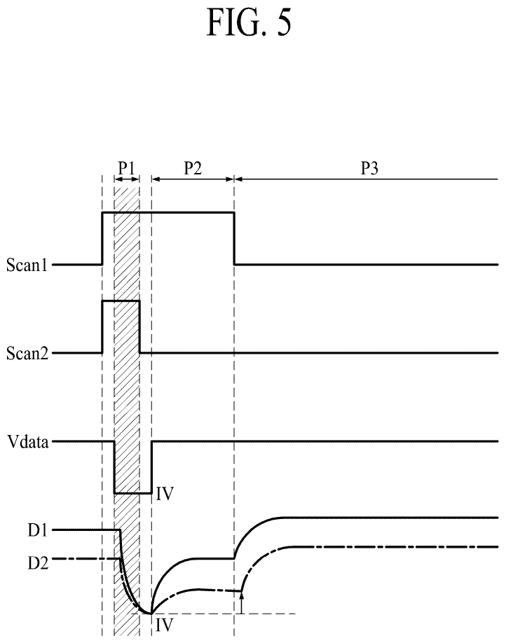

FIG. 4 illustrates an operation state of a pixel circuit in a first period of the subpixel shown in FIG. 3, according to one embodiment of the present disclosure. FIG. 5 illustrates voltage changes of nodes in the pixel circuit shown in FIG. 4, according to one embodiment of the present disclosure.

Referring to FIGS. 4 and 5, in the first period P1 of the subpixel SP, the first switching transistor ST1 may be turned on by the first scan signal Scan1 applied with a gate on voltage, and the second switching transistor ST2 may be turned on by the second scan signal Scan2 applied with a gate-on voltage. Also, the data line DL may receive a first data signal having an initialization voltage IV.

During the first period P1, as the first and second switching transistors ST1 and ST2 are turned on, the initialization voltage IV (or the first data signal) may be supplied to the first node N1 and the second node N2 of driving transistor DT. Accordingly, the voltage D1 of the first node N1 and the voltage D2 of the second node N2 may be initialized to the initialization voltage IV.

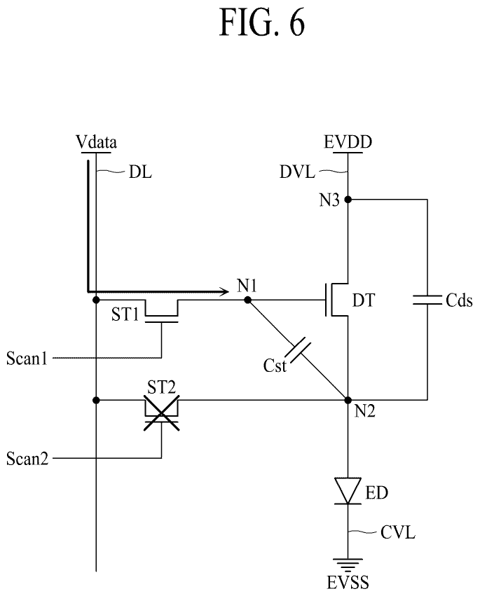

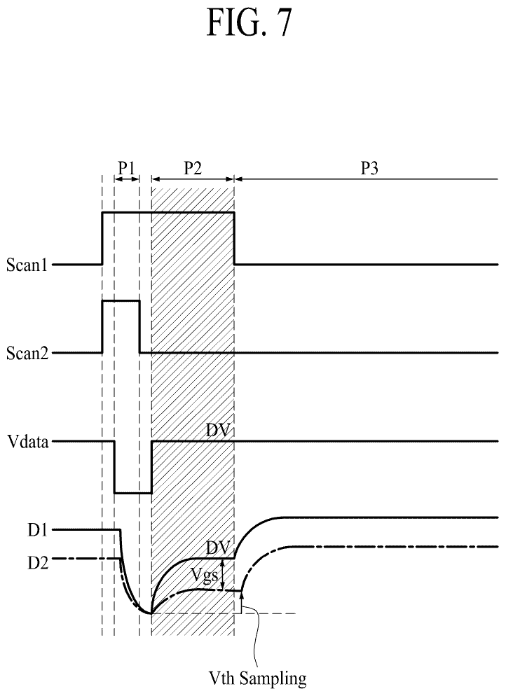

FIG. 6 illustrates an operation state of a pixel circuit in a second period of the subpixel shown in FIG. 3, according to one embodiment of the present disclosure. FIG. 7 illustrates voltage changes of nodes in the pixel circuit shown in FIG. 6, according to one embodiment of the present disclosure.

Referring to FIGS. 6 and 7, in the second period P2 of subpixel SP2, the first switching transistor ST1 may be maintained in a turned-on state by the first scan signal Scan1 maintaining the gate on voltage, and the second switching transistor ST2 may be switched to a turned-off state by the second scan signal Scan2 switched to the gate off voltage. Also, the data line DL may receive a second data signal having a data voltage DV.

During the second period P2, as the first switching transistor ST1 maintains a turned-on state, the data voltage DV (or the second data signal) may be supplied to the first node N1 of driving transistor DT. Also, the second node N2 of driving transistor DT may be electrically floated as the second switching transistor ST2 is turned off.

In the second period P2, the second node N2 of driving transistor DT may be electrically floated, and may reflect an electrical characteristic of the driving transistor DT based on the second capacitor Cds. For example, the electrical characteristic of driving transistor DT may include a threshold voltage or mobility of the driving transistor DT.

During the second period P2, the data voltage DV (or the second data signal) for data programming may be supplied to the first node N1 of driving transistor DT, and the voltage D1 of the first node N1 may increase to the data voltage DV. The programmed data voltage DV may be stored in the first capacitor Cst. The second node N2 of driving transistor DT may be electrically floated. Since the gate-source voltage Vgs of driving transistor DT is greater than the threshold voltage Vth of driving transistor DT, current may flow between the third node N3 and the second node N2 of driving transistor DT, and the voltage D2 of the second node N2 may rise to the threshold voltage Vth of driving transistor DT. Accordingly, a sampling voltage (Vth sampling) reflecting the threshold voltage Vth of driving transistor DT may be stored in the second node N2. For example, the sampling voltage (Vth sampling) reflecting the electrical characteristic of driving transistor DT may be stored in the second node N2 based on the second capacitor Cds.

The second capacitor Cds according to one embodiment of the present disclosure may be configured to limit a voltage rise of the second node N2 during the second period P2, thereby maintaining the gate-source voltage Vgs of driving transistor DT at an appropriate level. As a result, an electrical characteristic of driving transistor DT may be reflected in the second node N2, and sampling of the threshold voltage of driving transistor DT and data programming may be performed simultaneously.

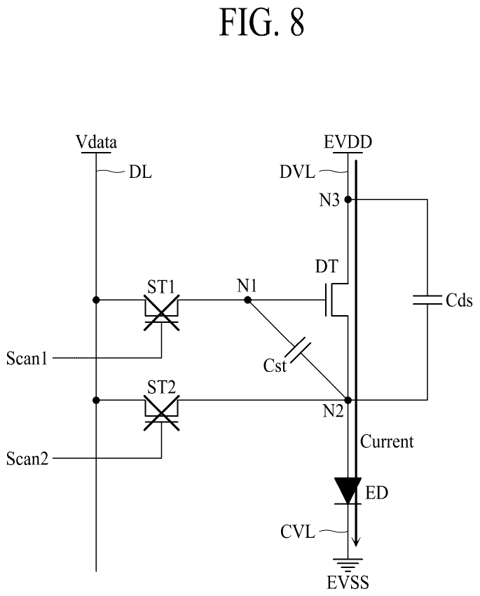

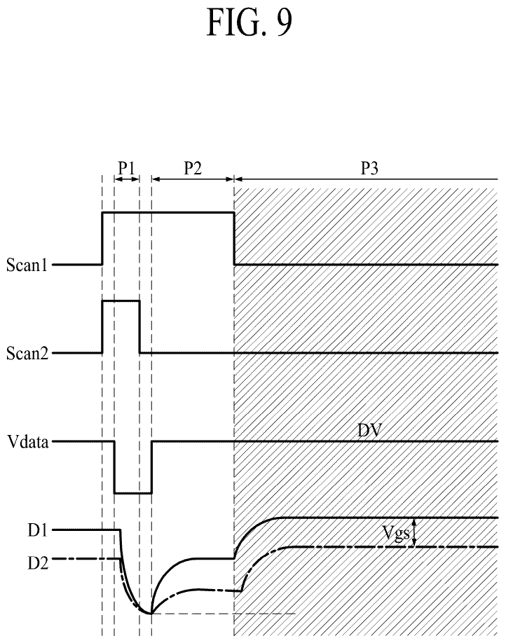

FIG. 8 illustrates an operation state of a pixel circuit in a third period of the subpixel shown in FIG. 3, according to one embodiment of the present disclosure. FIG. 9 illustrates voltage changes of nodes in the pixel circuit shown in FIG. 8, according to one embodiment of the present disclosure.

Referring to FIGS. 8 and 9, in the third period P3 of the subpixel SP, the first and second switching transistors ST1 and ST2 may maintain a turned-off state, and the data line DL may receive a second data signal having a data voltage DV.

During the third period P3, the driving transistor DT may be turned on according to the data voltage DV programmed in the first capacitor Cst, and may generate a driving current from the driving power voltage EVDD supplied through the driving power line DVL and deliver the driving current to the light emitting device ED.

During the third period P3, the gate-source voltage Vgs of driving transistor DT may be maintained constant by the first capacitor Cst.

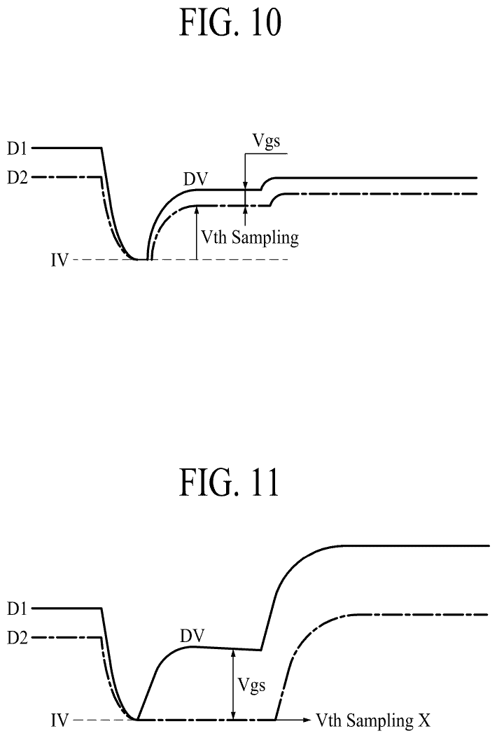

FIG. 10 illustrates voltage changes of nodes in the pixel circuit according to another embodiment of the present disclosure. FIG. 11 illustrates voltage changes of nodes in the pixel circuit according to another embodiment of the present disclosure.

Referring to FIGS. 10 and 11, the second capacitor Cds according to another embodiment of the present disclosure may compensate for a voltage of a second node N2 of the driving transistor DT according to a capacitance of the second capacitor Cds.

When a capacitance of the second capacitor Cds is configured to have a small value, a voltage D2 of the second node N2 may be stored as a sampling voltage (Vth sampling) in which a threshold voltage Vth of the driving transistor DT is sufficiently reflected, as shown in FIG. 10. For example, the capacitance of the second capacitor Cds may be 1 pF or less, but embodiments of the present disclosure are not limited thereto. Accordingly, the gate-source voltage Vgs of the driving transistor DT may be reduced due to an increase in the voltage D2 of the second node N2. Therefore, when the capacitance of the second capacitor Cds is small, a sampling characteristic of the driving transistor DT may be improved, but a luminance of the light emitting device ED may be slightly reduced due to a decrease in the gate-source voltage Vgs, resulting in a reduction in data transmission ratio.

When a capacitance of the second capacitor Cds is configured to have a large value, a voltage D2 of the second node N2 may approach an initialization voltage IV and a threshold voltage Vth of the driving transistor DT may not be sampled, as shown in FIG. 11. For example, the capacitance of the second capacitor Cds may be 1 pF or more, but embodiments of the present disclosure are not limited thereto. Accordingly, the gate-source voltage Vgs of the driving transistor DT may be increased due to a decrease in the voltage D2 of the second node N2. Therefore, when the capacitance of the second capacitor Cds is large, a sampling characteristic of the driving transistor DT may not be reflected, but a luminance of the light emitting device ED may be improved due to an increase in the gate-source voltage Vgs resulting in an increase in data transmission ratio.

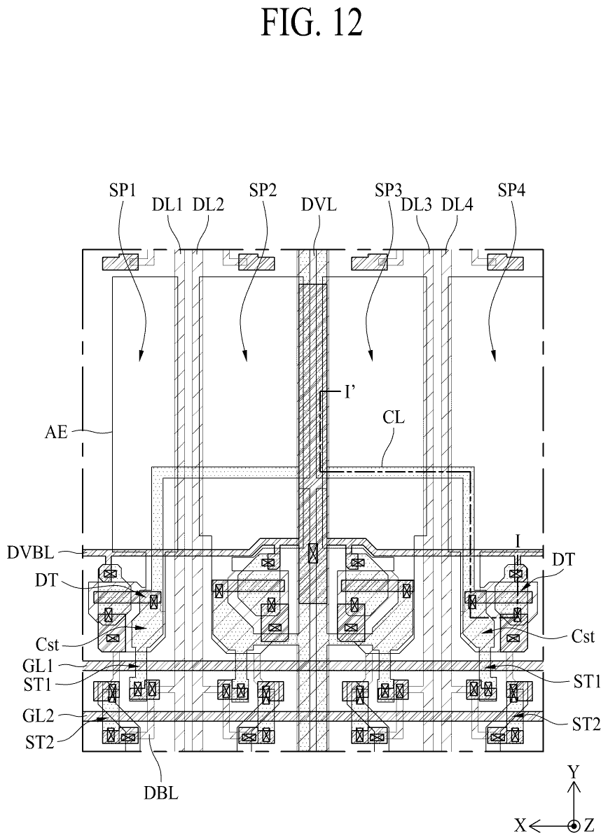

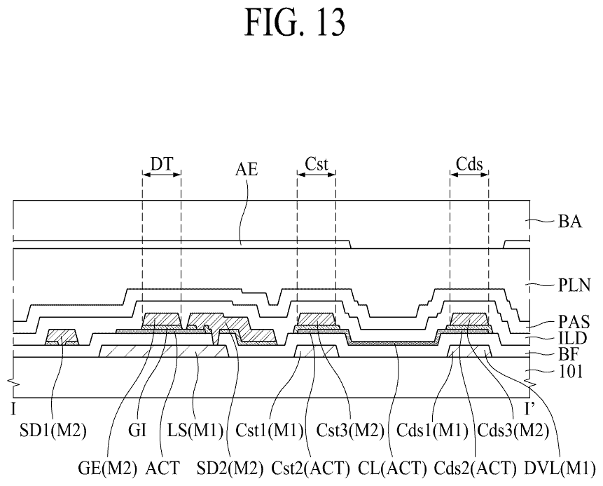

FIG. 12 illustrates a layout of a plurality of subpixels in a display panel according to another embodiment of the present disclosure. FIG. 13 is a cross-sectional view taken along line I-I′ shown in FIG. 12, according to another embodiment of the present disclosure.

Referring to FIGS. 12 and 13, the display panel 110 according to another embodiment of the present disclosure may be formed in a bottom emission type, and may be implemented in a structure that may secure a design margin of a voltage line by excluding a reference voltage line and improve an aperture ratio of a light emitting portion. Although FIGS. 12 and 13 describe the display panel 110 as the bottom emission type light emitting display panel, but embodiments of the present disclosure are not limited thereto and may also be implemented as a top emission type light emitting display panel.

Referring to FIG. 12, the display panel 110 according to another embodiment of the present disclosure may include a plurality of subpixels SP1, SP2, SP3 and SP4, which express different colors and form a unit pixel. The plurality of subpixels SP1, SP2, SP3 and SP4 may be arranged in a stripe manner along a first direction (or an X-axis direction) or a second direction (or a Y-axis direction). For example, the plurality of subpixels SP1, SP2, SP3 and SP4 may be arranged along the first direction (or the X-axis direction), but embodiments of the present disclosure are not limited thereto, and an arrangement order or a layout configuration may be variously modified.

Each of the plurality of subpixels SP1, SP2, SP3 and SP4 may include a light emitting device ED including a pixel electrode AE, an emission layer, and a common electrode, and a pixel circuit including at least one transistor DT, ST1 and ST2, a first capacitor Cst, and a second capacitor Cds. The plurality of subpixels SP1, SP2, SP3 and SP4 may also include at least one gate line GL1 and GL2, a plurality of data lines DL1, DL2, DL3 and DL4, and a driving voltage line DVL. For example, in the display panel 110, a portion in which the light emitting device ED is disposed may be an emission area (or an opening area), a portion in which the pixel circuit is disposed may be a circuit area (or a first non-emission area), and a portion in which the plurality of data lines DL1, DL2, DL3 and DL4 and the driving voltage line DVL are disposed may be a line area (or a second non-emission area).

According to another embodiment of the present disclosure, the display panel 110 may be implemented in the bottom emission type, and the emission area (or the opening area) in which the light emitting device ED is disposed and the circuit area (or the first non-emission area) in which the pixel circuit is disposed may not overlap with each other, or may partially overlap with each other. For example, the plurality of subpixels SP1, SP2, SP3 and SP4 may be arranged in the first direction (or the X-axis direction), the emission area may be disposed on an upper side in the second direction (or the Y-axis direction), and the circuit area may be disposed on a lower side in the second direction, but embodiments of the present disclosure are not limited thereto.

According to another embodiment of the present disclosure, the at least one transistor DT, ST1 and ST2 and the first capacitor Cst of the pixel circuit may be disposed in the circuit area (or the first non-emission area), the at least one gate line GL1 and GL2 may be disposed in the circuit area (or the first non-emission area), and the second capacitor Cds of the pixel circuit may be disposed in the line area (or the second non-emission area). For example, the second capacitor Cds may be disposed in the line area (or the second non-emission area) overlapping with the driving voltage line DVL.

The at least one gate line GL1 and GL2 may be disposed to overlap the circuit area. For example, the at least one gate line GL1 and GL2 may extend in the first direction (or X-axis direction) so as to cross the circuit area. The at least one gate line GL1 and GL2 may include a first gate line GL1 and a second gate line GL2. The first gate line GL1 may supply a first scan signal Scan1 to the first switching transistor ST1 of each subpixel SP1, SP2, SP3 and SP4, and the second gate line GL2 may supply a second scan signal Scan2 to the second switching transistor ST2 of each subpixel SP1, SP2, SP3 and SP4.

The plurality of data lines DL1, DL2, DL3 and DL4 may be disposed between the plurality of subpixels SP1, SP2, SP3 and SP4. For example, first and second data lines DL1 and DL2 may extend in the second direction (or Y-axis direction) between the first subpixel SP1 and the second subpixel SP2. The first data line DL1 may be disposed on the right side of the first subpixel SP1 to supply a data signal to the first subpixel SP1, and the second data line DL2 may be disposed on the left side of the second subpixel SP2 to supply a data signal to the second subpixel SP2. Also, third and fourth data lines DL3 and DL4 may extend in the second direction (or Y-axis direction) between the third subpixel SP3 and the fourth subpixel SP4. The third data line DL3 may be disposed on the right side of the third subpixel SP3 to supply a data signal to the third subpixel SP3, and the fourth data line DL4 may be disposed on the left side of the fourth subpixel SP4 to supply a data signal to the fourth subpixel SP4.

The driving voltage line DVL may be disposed within the plurality of subpixels SP1, SP2, SP3 and SP4. For example, the driving voltage line DVL may extend in the second direction (or Y-axis direction) between the second subpixel SP2 and the third subpixel SP3. The driving voltage line DVL may supply a driving power voltage EVDD to each of the subpixels SP1, SP2, SP3 and SP4 through a driving voltage bridge line DVBL extending in the first direction (or X-axis direction).

The pixel circuit of each subpixel SP1, SP2, SP3 and SP4 may include a driving transistor DT, a first switching transistor ST1, a second switching transistor ST2, a first capacitor Cst, and a second capacitor Cds.

The driving transistor DT may be disposed on an upper side of the circuit area. A gate electrode of the driving transistor DT may be connected to one end of the first capacitor Cst and a source electrode of the first switching transistor ST1. A drain electrode of the driving transistor DT may be connected to the driving voltage bridge line DVBL extending from the driving voltage line DVL, and a source electrode of the driving transistor DT may be connected to the pixel electrode AE of the light emitting device ED.

The first and second switching transistors ST1 and ST2 may be disposed on a lower side of the circuit area. A gate electrode of the first switching transistor ST1 may be configured as a portion of the first gate line GL1, a drain electrode of the first switching transistor ST1 may be connected to a data line DL, and a source electrode of the first switching transistor ST1 may be connected to one end of the first capacitor Cst and the gate electrode of the driving transistor DT. A gate electrode of the second switching transistor ST2 may be configured as a portion of the second gate line GL2, a drain electrode of the second switching transistor ST2 may be connected to a data bridge line DBL extending from the data line DL, and a source electrode of the second switching transistor ST2 may be connected to the source electrode of the driving transistor DT.

The first capacitor Cst may be disposed at a middle portion of the circuit area. One end of the first capacitor Cst may be connected between the gate electrode of the driving transistor DT and the source electrode of the first switching transistor ST1, and the other end of the first capacitor Cst may be connected between the source electrode of the driving transistor DT and the pixel electrode AE of the light emitting device ED. Also, the other end of the first capacitor Cst may be connected to the source electrode of the second switching transistor ST2. For example, the first capacitor Cst may be formed in a dual capacitance structure including a first electrode formed of the same material as a light blocking layer, a second electrode formed of a conductive active layer, and a third electrode formed of the same material as the gate electrode.

The second capacitor Cds may be disposed to overlap at least a portion of the driving voltage line DVL. One end of the second capacitor Cds may be connected to the driving voltage line DVL, and the other end of the second capacitor Cds may be connected between the source electrode of the driving transistor DT and the pixel electrode AE of the light emitting device ED via a connection line CL passing through the emission area. Also, the other end of the second capacitor Cds may be connected to the source electrode of the second switching transistor ST2. For example, the connection line CL of the second capacitor Cds may be formed of a conductive active layer. The second capacitor Cds may be formed in a dual capacitance structure including a first electrode formed of a portion of the driving voltage line DVL, a second electrode formed of a conductive active layer, and a third electrode formed of the same material as the gate electrode. For example, the driving voltage line DVL may be formed of the same material as the light blocking layer and in the same layer.

Referring to FIG. 13, the display panel 110 according to another embodiment of the present disclosure may include a first metal layer M1 disposed on a substrate 101, a first insulating layer BF (or buffer layer) disposed on the first metal layer M1, an active layer ACT (or semiconductor layer) disposed on the first insulating layer BF, a second insulating layer GI (or gate insulating layer) disposed on the active layer ACT, and a second metal layer M2 disposed on the second insulating layer GI. Also, at least one third insulating layer ILD and PAS (interlayer insulating layer or passivation layer) may be disposed on the second metal layer M2, a planarization layer PLN may be disposed on the at least one third insulating layer ILD and PAS, and the pixel electrode AE may be disposed on the planarization layer PLN. Also, a bank layer BA may be disposed on the planarization layer PLN and the pixel electrode AE.

The first metal layer M1 may be disposed on the substrate 101 and may serve as a light blocking layer that blocks external light incident on the active layer ACT of the at least one transistor DT, ST1 and ST2. For example, the light blocking layer may be formed as a single layer or a multilayer made of any one of molybdenum (Mo), aluminum (Al), chromium (Cr), gold (Au), titanium (Ti), nickel (Ni), neodymium (Nd), and copper (Cu), or an alloy thereof, but embodiments of the present disclosure are not limited thereto.

The first metal layer M1 may be configured as at least one signal line or at least one power line. For example, at least one of the data line DL and the driving voltage line DVL may be formed of the first metal layer M1. Also, at least one of the first electrode Cst1 of the first capacitor Cst and the first electrode Cds1 of the second capacitor Cds may be formed of the first metal layer M1.

The first insulating layer BF (or buffer layer) may be disposed on the substrate 101 so as to cover the first metal layer M1. The first insulating layer BF is configured to prevent diffusion of impurity ions, penetration of moisture or ambient air, and to insulate the first metal layer ML1 and the active layer ACT. The first insulating layer BF may be formed of a single layer or multiple layers including an inorganic insulating material, but embodiments of the present disclosure are not limited thereto.

The active layer ACT (or semiconductor layer) may be disposed on the first insulating layer BF. The active layer ACT may be formed of an oxide semiconductor material or a silicon-based semiconductor material, but embodiments of the present disclosure are not limited thereto. The active layer ACT may constitute a semiconductor channel of the at least one transistor DT, ST1 and ST2. Also, the active layer ACT may be conductive and configured as a conductive electrode or line. For example, at least one of a second electrode Cst2 of the first capacitor Cst and a second electrode Cds2 of the second capacitor Cds may be formed of the conductive active layer ACT. The conductive active layer ACT constituting the second capacitor Cds may be disposed to overlap the driving voltage line DVL. Also, the connection line CL of the second capacitor Cds may be formed of the conductive active layer ACT.

The second insulating layer GI (or gate insulating layer) may be disposed on the first insulating layer BF so as to cover at least a portion or an entirety of the active layer ACT. For example, the second insulating layer GI may be disposed between the active layer ACT and the second metal layer M2. The second insulating layer GI may be patterned together with the second metal layer M2 in a process of patterning the second metal layer M2. The second insulating layer GI is configured to prevent diffusion of impurity ions and to insulate the active layer ACT and the second metal layer M2. The second insulating layer GI may be formed of a single layer or multiple layers including an inorganic insulating material, but embodiments of the present disclosure are not limited thereto.

The second metal layer M2 may be disposed on the second insulating layer GI. The second metal layer M2 may be disposed on the second insulating layer GI and patterned together with the second insulating layer GI. The second metal layer M2 may constitute a gate electrode GE or a source/drain electrode SD1 and SD2 of the at least one transistor DT, ST1 and ST2. Also, the second metal layer M2 may constitute at least one signal line or at least one power line. For example, at least one of the gate line GL, the driving voltage line DVL, and the driving voltage bridge line DVBL may be formed of the second metal layer M2. Also, at least one of a third electrode Cst3 of the first capacitor Cst and a third electrode Cds3 of the second capacitor Cds may be formed of the second metal layer M2. For example, the third electrode Cds3 of the second capacitor Cds may be disposed to overlap the driving voltage line DVL.

The at least one third insulating layer ILD and PAS (interlayer insulating layer or passivation layer) may be disposed on the second metal layer M2. For example, the at least one third insulating layer ILD and PAS may include an interlayer insulating layer ILD and a passivation layer PAS. The at least one third insulating layer ILD and PAS may be disposed to cover a gate electrode GE and first and second source/drain electrodes SD1 and SD2 of the at least one transistor DT, ST1 and ST2. The at least one third insulating layer ILD and PAS is configured to protect the at least one transistor DT, ST1 and ST2, and may be formed of a single layer or multiple layers including an inorganic insulating material, but embodiments of the present disclosure are not limited thereto. For example, one of the interlayer insulating layer ILD and the passivation layer PAS may be omitted.

The display panel 110 according to another embodiment of the present disclosure may exclude a reference voltage line and may dispose the driving voltage line DVL within the plurality of subpixels SP1, SP2, SP3 and SP4, thereby securing design margin of the pixel circuit and voltage lines and improving an aperture ratio of a light emitting portion.

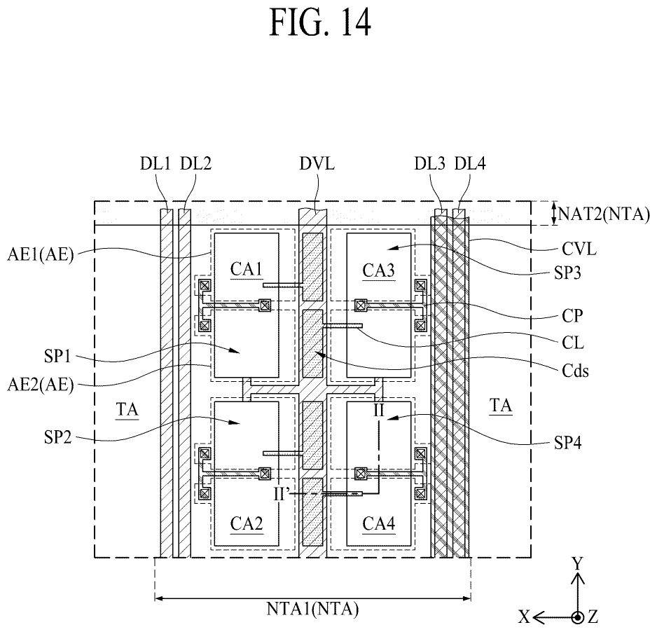

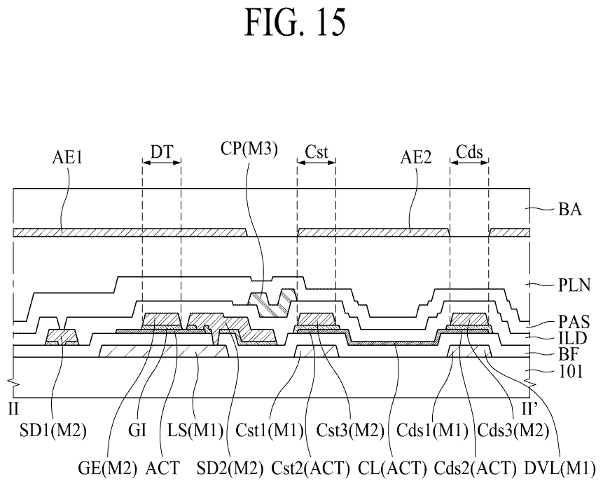

FIG. 14 illustrates a layout of a plurality of subpixels in a display panel according to another embodiment of the present disclosure. FIG. 15 is a cross-sectional view taken along line II-II′ shown in FIG. 14, according to another embodiment of the present disclosure. FIGS. 14 and 15 illustrate embodiments of the present disclosure in which a configuration of the display panel 110 is modified in the light emitting display apparatus described with reference to FIGS. 1 to 13. In the following description referring to FIGS. 14 and 15, the same reference numerals will be used for the same components, except for the modified configurations, and their redundant descriptions will be omitted or briefly described.

Referring to FIGS. 14 and 15, the display panel 110 according to another embodiment of the present disclosure may be a transparent display panel formed in a top emission type or a dual emission type. The display panel 110 may be configured to improve the design margin for voltage lines by excluding a reference voltage line, and enhance an aperture ratio of a light emitting portion and a transparency of the transmissive area. Although FIGS. 14 and 15 describe the display panel 110 as the transparent display panel including the transmissive area in the top emission type, embodiments of the present disclosure are not limited thereto and may be implemented in the bottom emission type or as a light emitting display panel without the transmissive area.

Referring to FIG. 14, in the display panel 110 according to another embodiment of the present disclosure, a plurality of subpixels SP1, SP2, SP3 and SP4 may be disposed adjacent to each other in a first direction (or X-axis direction) and a second direction (or Y-axis direction). The plurality of subpixels SP1, SP2, SP3 and SP4 may be disposed in a matrix in a quad format along the first and second directions. For example, a first subpixel SP1 and a second subpixel SP2 may be disposed on the left side of a driving voltage line DVL, and a third subpixel SP3 and a fourth subpixel SP4 may be disposed on the right side of the driving voltage line DVL.

According to another embodiment of the present disclosure, the display panel 110 may be implemented as the transparent display panel in the top emission type and may include a non-transmissive area NTA, in which the plurality of subpixels SP1, SP2, SP3 and SP4 are disposed, and a transmissive area TA. For example, the plurality of subpixels SP1, SP2, SP3 and SP4 may be disposed adjacent to one another in the first and second directions. Also, the transmissive area TA may be disposed adjacent to the plurality of subpixels SP1, SP2, SP3 and SP4 in the first direction. The transmissive area TA may be an area that transmits most of the light incident from the outside, and the non-transmissive area NTA may be an area that does not transmit most of the light incident from the outside. For example, the transmissive area TA may be an area having light transmittance greater than a %, and the non-transmissive area NTA may be an area having light transmittance smaller than b %. In this case, a may be a value greater than b. The light emitting display apparatus according to another embodiment of the present disclosure may see an object or a background, which is positioned on a back surface (or a rear surface) of the display panel 110, due to the transmissive area TA.

The non-transmissive area NTA may include a first non-transmissive area NTA1, a second non-transmissive area NTA2, and the plurality of subpixels SP1, SP2, SP3 and SP4.

The first non-transmissive area NTA1 may extend in the second direction (or Y-axis direction) within the display panel 110, and each of the subpixels SP1, SP2, SP3 and SP4 may be disposed within the first non-transmissive area NTA1.

The first non-transmissive area NTA1 may be formed in plurality. The plurality of first non-transmissive areas NTA1 may extend in the second direction and may be spaced apart from one another in the first direction (or X-axis direction). Two adjacent first non-transmissive areas NTA1 may be spaced apart from each other with the transmissive area TA interposed therebetween. For example, the transmissive area TA may be disposed between two adjacent first non-transmissive areas NTA1. At least one signal line and at least one voltage line extending in the second direction may be disposed in the first non-transmissive area NTA1. For example, the at least one signal line may include a plurality of data lines DL1, DL2, DL3 and DL4, and the at least one voltage line may include a driving voltage line DVL and a common voltage line CVL.

The plurality of data lines DL1, DL2, DL3 and DL4 may be disposed adjacent to the plurality of subpixels SP1, SP2, SP3 and SP4. For example, first and second data lines DL1 and DL2 may be disposed to the left of the first and second subpixels SP1 and SP2. The first data line DL1 may be disposed at the far left in the first direction, and the second data line DL2 may be disposed between the first data line DL1 and the first and second subpixels SP1 and SP2. Also, third and fourth data lines DL3 and DL4 may be disposed to the right of the third and fourth subpixels SP3 and SP4. The fourth data line DL4 may be disposed at the far right in the first direction, and the third data line DL3 may be disposed between the third and fourth subpixels SP3 and SP4 and the fourth data line DL4.

The driving voltage line DVL (or first power supply voltage line) may be disposed within the plurality of subpixels SP1, SP2, SP3 and SP4. For example, the driving voltage line DVL may be disposed between the first and second subpixels SP1 and SP2 and the third and fourth subpixels SP3 and SP4. The driving voltage line DVL may supply a driving power voltage EVDD to each of the subpixels SP1, SP2, SP3 and SP4 through a driving voltage bridge line DVBL extending in the first direction.

The common voltage line CVL (or second power supply voltage line) may supply a second power voltage EVSS to the cathode electrodes of subpixels SP1, SP2, SP3 and SP4. For example, the second power voltage EVSS may be a common power supply shared by the plurality of subpixels SP1, SP2, SP3 and SP4. The common voltage line CVL may be disposed to either the left or right of the subpixels SP1, SP2, SP3 and SP4. For example, the common voltage line CVL may be disposed to the right of the plurality of subpixels SP1, SP2, SP3 and SP4 and may overlap at least a portion of the plurality of data lines DL1, DL2, DL3 and DL4. For example, the common voltage line CVL may overlap the third and fourth data lines DL3 and DL4.

The second non-transmissive area NTA2 may extend in the first direction within the display panel 110 and may be disposed to overlap at least a portion of each of the subpixels SP1, SP2, SP3 and SP4. For example, the second non-transmissive area NTA2 may extend in the first direction between two adjacent first non-transmissive areas NTA1. A plurality of second non-transmissive areas NTA2 may be provided and may extend in the first direction and be spaced apart from each other in the second direction. Two adjacent second non-transmissive areas NTA2 may be spaced apart with the transmissive area TA interposed therebetween. At least one gate line extending in the first direction may be disposed in the second non-transmissive area NTA2 and may overlap the second non-transmissive area NTA2.

The plurality of subpixels SP1, SP2, SP3 and SP4 may be disposed at intersections of the first and second non-transmissive areas NTA1 and NTA2, and may emit light to display an image. Each of the subpixels SP1, SP2, SP3 and SP4 may include an emission area in which a light emitting device ED is disposed and a circuit area CA1, CA2, CA3 and CA4 overlapping at least one transistor DT, ST1 and ST2 and a first capacitor Cst.

According to another embodiment of the present disclosure, each subpixel SP1, SP2, SP3 and SP4 may include a light emitting area divided into a plurality of regions. For example, a pixel electrode AE (first electrode or anode electrode) of each of the subpixels SP1, SP2, SP3 and SP4 may include a first pixel electrode AE1 and a second pixel electrode AE2 separated from each other. The first and second pixel electrodes AE1 and AE2 may be spaced apart from each other in the first direction (or X-axis direction) or the second direction (or Y-axis direction). For example, the first and second pixel electrodes AE1 and AE2 may be disposed adjacent to each other in the second direction. Accordingly, each of the subpixels SP1, SP2, SP3 and SP4 may include two divided emission areas.

The circuit areas CA1, CA2, CA3 and CA4 of each of the subpixels SP1, SP2, SP3 and SP4 may include a driving transistor DT, a first switching transistor ST1, a second switching transistor ST2 and the first capacitor Cst of a pixel circuit. A second capacitor Cds of the pixel circuit may be disposed to overlap the driving voltage line DVL.

The second capacitor Cds may be disposed to overlap at least a portion of the driving voltage line DVL. One end of the second capacitor Cds may be connected to the driving voltage line DVL, and the other end of the second capacitor Cds may be connected to the circuit area CA1, CA2, CA3 and CA4 through a connection line CL. For example, the connection line CL of the second capacitor Cds may be formed of a conductive active layer. The second capacitor Cds may be formed in a dual capacitance structure including a first electrode formed of a portion of the driving voltage line DVL, a second electrode formed of the conductive active layer, and a third electrode formed of the same material as the gate electrode. For example, the driving voltage line DVL may be formed of the same material in the same layer as a light blocking layer.

The second capacitor Cds may be configured as a plurality of second capacitors Cds disposed on the driving voltage line DVL. The plurality of second capacitors Cds may be connected to the pixel circuits CA1, CA2, CA3 and CA4 of the plurality of subpixels SP1, SP2, SP3 and SP4. For example, the second capacitor Cds corresponding to the first subpixel SP1 may be disposed on an upper side of the driving voltage line DVL adjacent to the first subpixel SP1 in the second direction (or Y-axis direction), and may be connected to the pixel circuit CA1 of the first subpixel SP1 through the connection line CL extending to the left in the first direction (or X-axis direction). Also, the second capacitor Cds corresponding to the second subpixel SP2 may be disposed on a middle-lower side of the driving voltage line DVL adjacent to the second subpixel SP2 in the second direction, and may be connected to the pixel circuit CA2 of the second subpixel SP2 through the connection line CL extending to the left in the first direction. Also, the second capacitor Cds corresponding to the third subpixel SP3 may be disposed on a middle-upper side of the driving voltage line DVL adjacent to the third subpixel SP3 in the second direction, and may be connected to the pixel circuit CA3 of the third subpixel SP3 through the connection line CL extending to the right in the first direction. Also, the second capacitor Cds corresponding to the fourth subpixel SP4 may be disposed on a lower side of the driving voltage line DVL adjacent to the fourth subpixel SP4 in the second direction, and may be connected to the pixel circuit CA4 of the fourth subpixel SP4 through the connection line CL extending to the right in the first direction, but embodiments of the present disclosure are not limited thereto. For example, the second capacitors Cds corresponding to each of the subpixels SP1, SP2, SP3 and SP4 may be configured separately from each other or connected together in common on the driving voltage line DVL, but embodiments of the present disclosure are not limited thereto.

The divided first and second pixel electrodes AE1 and AE2 of each of the subpixels SP1, SP2, SP3 and SP4 may be electrically connected to the circuit areas CA1, CA2, CA3 and CA4 through a connection pattern CP. Also, the first and second pixel electrodes AE1 and AE2 may be electrically connected to each other through the connection pattern CP. The connection pattern CP may serve to repair darkening in any one of the first and second pixel electrodes AE1 and AE2. For example, the connection pattern CP may be configured in “T” shape. One end of the connection pattern CP may be branched toward both sides to be electrically connected to each of the first and second pixel electrodes AE1 and AE2, and the other end of the connection pattern CP may be electrically connected to the circuit areas CA1, CA2, CA3 and CA4 of each of the subpixels SP1, SP2, SP3 and SP4. The connection pattern CP may block the electrical connection between a pixel electrode with foreign material and the circuit areas CA1, CA2, CA3 and CA4, when the foreign material occurs on either the first pixel electrode AE1 or the second pixel electrode AE2, thereby causing only the pixel electrode with the foreign material to be darkened, while repairing the other pixel electrode to operate normally.

Referring to FIG. 15, the display panel 110 according to another embodiment of the present disclosure may further include a third metal layer M3. For example, at least one third insulating layer ILD and PAS may include an interlayer insulating layer ILD and a passivation layer PAS, and the third metal layer M3 may be disposed between the interlayer insulating layer ILD and the passivation layer PAS. The third metal layer M3 may be configured as at least one signal line or at least one power line. For example, at least one of the common voltage line CVL and the connection pattern CP may be formed in the third metal layer M3. For example, the third metal layer M3 may serve as a portion of the second capacitor Cds, thereby enabling a triple capacitance structure to be formed for the second capacitor Cds.

The display panel 110 according to another embodiment of the present disclosure may secure the design margin for the pixel circuit and voltage lines and improve both the aperture ratio of the light emitting portion and the transparency of the transmissive area TA by excluding the reference voltage line, disposing the driving voltage line DVL within the plurality of subpixels SP1, SP2, SP3 and SP4, and overlapping the common voltage line CVL with at least a portion of the data lines DL1, DL2, DL3 and DL4.

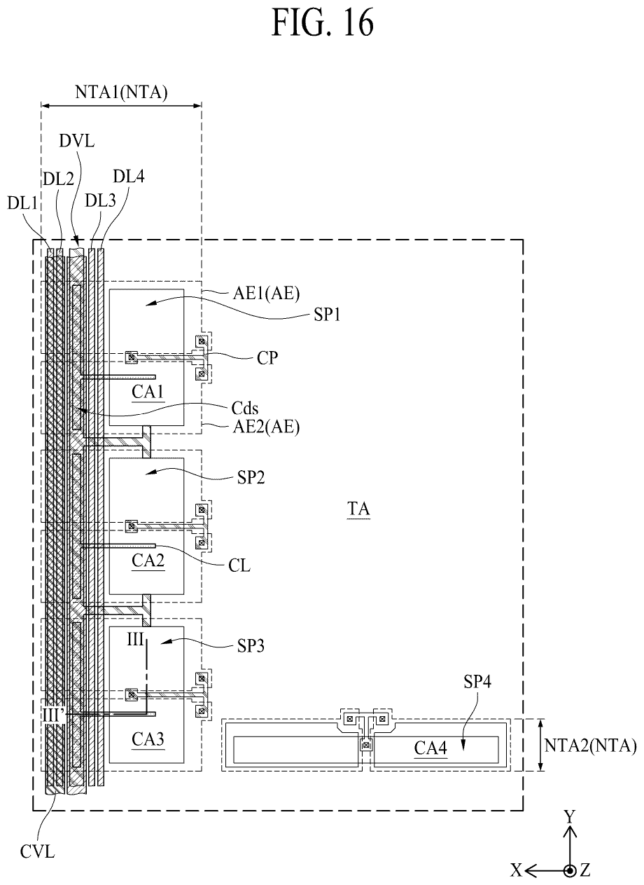

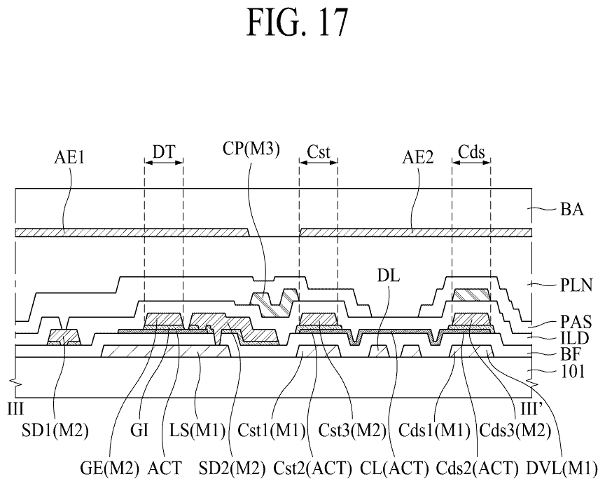

FIG. 16 illustrates a layout of a plurality of subpixels in a display panel according to another embodiment of the present disclosure. FIG. 17 is a cross-sectional view taken along line III-III′ shown in FIG. 16, according to another embodiment of the present disclosure. FIGS. 16 and 17 illustrate embodiments of the present disclosure in which the configuration of the display panel 110 is modified in the light emitting display apparatus described with reference to FIGS. 1 to 15. In the following description referring to FIGS. 16 and 17, the same reference numerals will be used for the same components, except for the modified configurations, and their redundant descriptions will be omitted or briefly described.

Referring to FIGS. 16 and 17, the display panel 110 according to another embodiment of the present disclosure may be a transparent display panel formed in a top emission type or a dual emission type, and may be implemented in a structure capable of securing the design margin for voltage lines by excluding a reference voltage line, and improving the aperture ratio of the light emitting portion and the transparency of a transmissive area. Although FIGS. 16 and 17 describe the display panel 110 as the transparent display panel including a transmissive area in the top emission type, embodiments of the present disclosure are not limited thereto and may be implemented in the bottom emission type or as a light emitting display panel without the transmissive area.

Referring to FIG. 16, in the display panel 110 according to another embodiment of the present disclosure, a plurality of subpixels SP1, SP2, SP3 and SP4 may be arranged in different directions to form a cross shape or a pinwheel shape. For example, at least some of the subpixels SP1, SP2, SP3 and SP4 may be arranged in a first direction, and at least some other subpixels may be arranged in a second direction. For example, first to third subpixels SP1, SP2 and SP3 among the plurality of subpixels SP1, SP2, SP3 and SP4 may be arranged in the second direction, and a fourth subpixel SP4 among the plurality of subpixels SP1, SP2, SP3 and SP4 may be arranged in the first direction.

A plurality of data lines DL1, DL2, DL3 and DL4 may be disposed adjacent to the plurality of subpixels SP1, SP2, SP3 and SP4. For example, the plurality of data lines DL1, DL2, DL3 and DL4 may be disposed to the left of the subpixels SP1, SP2, SP3 and SP4. For example, a first data line DL1 may be disposed at the far left in the first direction, and a fourth data line DL4 may be disposed adjacent to the first to third subpixels SP1, SP2 and SP3. A second data line DL2 may be disposed adjacent to the first data line DL1, and a third data line DL3 may be disposed adjacent to the fourth data line DL4.

A driving voltage line DVL (or first power supply voltage line) may be disposed between the plurality of data lines DL1, DL2, DL3 and DL4. For example, the driving voltage line DVL may be disposed between the first and second data lines DL1 and DL2 and the third and fourth data lines DL3 and DL4. The driving voltage line DVL may supply a driving power voltage EVDD to each of the subpixels SP1, SP2, SP3 and SP4 through a driving voltage bridge line DVBL extending in the first direction.

A common voltage line CVL (or second power supply voltage line) may be disposed to the left or right of the plurality of subpixels SP1, SP2, SP3 and SP4. For example, the common voltage line CVL may be disposed to the left of the plurality of subpixels SP1, SP2, SP3 and SP4. The common voltage line CVL may overlap at least a portion of the plurality of data lines DL1, DL2, DL3 and DL4. For example, the common voltage line CVL may overlap the first and second data lines DL1 and DL2.

Circuit areas CA1, CA2, CA3 and CA4 of each of the subpixels SP1, SP2, SP3 and SP4 may include a driving transistor DT, a first switching transistor ST1, a second switching transistor ST2, and a first capacitor Cst of a pixel circuit, and a second capacitor Cds of the pixel circuit may be disposed to overlap the driving voltage line DVL.

The second capacitor Cds may be disposed to overlap at least a portion of the driving voltage line DVL. One end of the second capacitor Cds may be connected to the driving voltage line DVL, and the other end may be connected to the circuit areas CA1, CA2, CA3 and CA4 through a connection line CL. For example, the connection line CL of the second capacitor Cds may be formed of a conductive active layer. The second capacitor Cds may be formed in a dual capacitance structure including a first electrode formed of a portion of the driving voltage line DVL, a second electrode formed of the conductive active layer, and a third electrode formed of the same material as a gate electrode. For example, the driving voltage line DVL may be formed of the same material in the same layer as a light blocking layer.

According to another embodiment of the present disclosure, the second capacitor Cds may be formed in a triple capacitance structure. For example, a fourth electrode formed of the same material as the common voltage line CVL may be disposed to overlap the driving voltage line DVL to form the triple capacitance structure.

According to another embodiment of the present disclosure, the second capacitor Cds may be disposed in first to third subpixels SP1, SP2 and SP3 among the plurality of subpixels SP1, SP2, SP3 and SP4, and may be omitted from the fourth subpixel SP4. For example, since the fourth subpixel SP4 is arranged in the first direction and its circuit area CA4 is extended in the first direction, the first capacitor Cst of the fourth subpixel SP4 may have a larger capacitance than those of the other subpixels SP1, SP2 and SP3, and thus the second capacitor Cds providing additional capacitance may be omitted.

The second capacitor Cds may be configured as a plurality of second capacitors Cds disposed on the driving voltage line DVL. The plurality of second capacitors Cds may be connected to the pixel circuits CA1, CA2 and CA3 of the subpixels SP1, SP2 and SP3 among the plurality of subpixels SP1, SP2, SP3 and SP4. For example, the second capacitor Cds corresponding to the first subpixel SP1 may be disposed on an upper side of the driving voltage line DVL adjacent to the first subpixel SP1 in the second direction, and may be connected to the pixel circuit CA1 of the first subpixel SP1 through a connection line CL extending to the right in the first direction. Also, the second capacitor Cds corresponding to the second subpixel SP2 may be disposed on a middle portion of the driving voltage line DVL adjacent to the second subpixel SP2 in the second direction, and may be connected to the pixel circuit CA2 through a connection line CL extending to the right in the first direction. Also, the second capacitor Cds corresponding to the third subpixel SP3 may be disposed on a lower side of the driving voltage line DVL adjacent to the third subpixel SP3 in the second direction, and may be connected to the pixel circuit CA3 through a connection line CL extending to the right in the first direction, but, embodiments of the present disclosure are not limited thereto. For example, the second capacitors Cds corresponding to the subpixels SP1, SP2 and SP3 may be configured separately from one another or may be connected in common on the driving voltage line DVL.

Referring to FIG. 17, the display panel 110 according to another embodiment of the present disclosure may further include a third metal layer M3. The third metal layer M3 may be configured as at least one signal line or at least one power line. For example, at least one of the common voltage line CVL, the connection pattern CP, and the driving voltage bridge line DVBL may be formed in the third metal layer M3. For example, the third metal layer M3 may serve as a portion of the second capacitor Cds, thereby forming the second capacitor Cds in a triple capacitance structure.

The second capacitor Cds may include a first electrode Cds1 formed of a first metal layer M1, a second electrode Cds2 formed of an active layer ACT, a third electrode Cds3 formed of a second metal layer M2, and a fourth electrode Cds4 formed of the third metal layer M3.

The display panel 110 according to another embodiment of the present disclosure may secure a design margin for the pixel circuit and voltage lines and improve both the aperture ratio of the light emitting portion and the transparency of the transmissive area TA by excluding the reference voltage line, disposing the driving voltage line DVL between the data lines DL1, DL2, DL3 and DL4, and overlapping the common voltage line CVL with at least a portion of the data lines DL1, DL2, DL3 and DL4.

A light emitting display apparatus according to one or more embodiments of the present disclosure will be described below.

A light emitting display apparatus according to one or more embodiments of the present disclosure may include a display panel including a plurality of subpixels connected to data lines, gate lines, and driving voltage lines, a data driving circuit configured to supply data signals to the data lines, and a gate driving circuit configured to supply scan signals to the gate lines, each of the plurality of subpixels may include a light emitting device, a driving transistor configured to connect between the driving voltage line and the light emitting device, and to control a current flowing through the light emitting device, a first switching transistor configured to connect between a first node of the driving transistor and the data line, a second switching transistor configured to connect between a second node of the driving transistor, which is connected to the light emitting device, and the data line, a first capacitor connected between the first node and the second node, and a second capacitor connected between a third node of the driving transistor, which is connected to the driving voltage line, and the second node.

According to one or more embodiments of the present disclosure, a voltage of the second node may correspond to a capacitance of the second capacitor.

According to one or more embodiments of the present disclosure, a voltage of the second node may be in proportion to a capacitance of the second capacitor.

According to one or more embodiments of the present disclosure, the second node may be electrically floating when the second switching transistor is turned off, and may reflect an electrical characteristic of the driving transistor based on the second capacitor.

According to one or more embodiments of the present disclosure, the electrical characteristic of the driving transistor may include one or more of a threshold voltage or a mobility of the driving transistor.

According to one or more embodiments of the present disclosure, each of the plurality of subpixels may be driven according to a first period, a second period, and a third period, and the data driving circuit may be configured to supply a first data signal having an initialization voltage during the first period, and to supply a second data signal having a data voltage higher than the initialization voltage during the second and third periods.

According to one or more embodiments of the present disclosure, the first period may be a period in which the first node and the second node are initialized to the initialization voltage, in the second period, programming of the data voltage and sampling of an electrical characteristic of the driving transistor are performed simultaneously, and in the third period, the light emitting device is driven to emit light based on the data voltage.

According to one or more embodiments of the present disclosure, the programmed data voltage may be stored in the first capacitor, and a sampling voltage reflecting the electrical characteristic of the driving transistor may be stored in the second node based on the second capacitor.

According to one or more embodiments of the present disclosure, the first switching transistor may be controlled by a first scan signal supplied from the gate driving circuit, and the second switching transistor may be controlled by a second scan signal supplied from the gate driving circuit.

According to one or more embodiments of the present disclosure, the first period may start at a timing when the first data signal is supplied, may overlap with ON states of the first and second scan signals, and may end at a timing when the second scan signal is switched to an OFF state.

According to one or more embodiments of the present disclosure, the first and second scan signals may be switched to an ON state before the first period.

According to one or more embodiments of the present disclosure, the second period may start at a timing when the second data signal is supplied, may overlap with an ON state of the first scan signal, and may end at a timing when the first scan signal is switched to an OFF state.

According to one or more embodiments of the present disclosure, the second scan signal may be switched to an OFF state before the second period.

According to one or more embodiments of the present disclosure, the third period may start at a timing when the first scan signal is switched to an OFF state, during the third period, which the second data signal may be maintained, and the third period may end at a timing when the first and second scan signals are switched to an ON state.

According to one or more embodiments of the present disclosure, the gate lines may extend in a first direction, the data lines and the driving voltage lines may extend in a second direction intersecting the first direction, the plurality of subpixels may be arranged in the first direction or the second direction, and the driving voltage lines may be disposed within the plurality of subpixels.

According to one or more embodiments of the present disclosure, the plurality of subpixels may include a first subpixel, a second subpixel, a third subpixel, and a fourth subpixel, and the driving voltage line may be disposed between a second data line of the second subpixel and a third data line of the third subpixel.

According to one or more embodiments of the present disclosure, the second capacitor may be a dual capacitance structure or a triple capacitance structure overlapping at least a portion of the driving voltage line.

According to one or more embodiments of the present disclosure, the light emitting device may include a pixel electrode, an emission layer, and a common electrode, the light emitting device may further include a common voltage line connected to the common electrode, and the common voltage line may extend in the second direction and may be disposed to overlap at least a portion of the data lines.

According to one or more embodiments of the present disclosure, the display panel may include a substrate, a first metal layer on the substrate, a first insulating layer on the first metal layer, a semiconductor layer on the first insulating layer, a second insulating layer on the semiconductor layer, a second metal layer on the second insulating layer, a third insulating layer on the second metal layer, and a third metal layer on the third insulating layer or in the third insulating layer.

According to one or more embodiments of the present disclosure, at least one of the data lines and the driving voltage lines may be formed of the first metal layer, the driving transistor may be formed of the semiconductor layer and the second metal layer, the first capacitor may be formed of the first metal layer, the semiconductor layer included in the driving transistor, and the second metal layer included in the driving transistor, and the second capacitor may be formed of the first metal layer included in the driving voltage line, the semiconductor layer overlapping the driving voltage line, and the second metal layer overlapping the driving voltage line.

According to one or more embodiments of the present disclosure, the second capacitor may be electrically connected to the second node of the driving transistor through a connection line formed of the same material as the semiconductor layer.

According to one or more embodiments of the present disclosure, the light emitting display may further include a common voltage line formed of the third metal layer and overlapping at least a portion of the data lines, the second capacitor may be formed of the first metal layer included in the driving voltage line, the semiconductor layer overlapping the driving voltage line, the second metal layer overlapping the driving voltage line, and the third metal layer overlapping the driving voltage line.

According to one or more embodiments of the present disclosure, the third insulating layer may include an interlayer insulating layer and a passivation layer, and the third metal layer is disposed between the interlayer insulating layer and the passivation layer.

A light emitting display apparatus according to one or more embodiments of the present disclosure may include a display panel including a plurality of subpixels connected to data lines, gate lines, and driving voltage lines; wherein the plurality of subpixels includes at least one first subpixel arranged along a first direction and a plurality of second subpixels arranged along a second direction intersecting the first direction, wherein each of the plurality of subpixels comprises a light emitting device and a subpixel circuit configured to drive the light emitting device, wherein the subpixel circuit of the at least one first subpixel arranged along the first direction comprises: a driving transistor configured to connect between the driving voltage line and the light emitting device, and to control a current flowing through the light emitting device, a first switching transistor configured to connect between a first node of the driving transistor and the data line, a second switching transistor configured to connect between a second node of the driving transistor, which is connected to the light emitting device, and the data line, a first capacitor connected between the first node and the second node, and wherein the subpixel circuit of each of the plurality of second subpixels arranged along the second direction comprises the driving transistor, the first switching transistor, the second switching transistor, the first capacitor, and a second capacitor connected between a third node of the driving transistor, which is connected to the driving voltage line, and the second node.

According to one or more embodiments of the present disclosure, a capacitance of the first capacitor in the subpixel circuit of the at least one first subpixel may be larger than a capacitance of the first capacitor in the subpixel circuit of each of the plurality of second subpixels.

A pixel circuit according to one or more embodiments of the present disclosure may be configured to drive a light emitting device, and may include a driving transistor configured to connect between a driving voltage line and the light emitting device, and to control a current flowing through the light emitting device, a first switching transistor configured to connect between a first node of the driving transistor and a data line, a second switching transistor configured to connect between a second node of the driving transistor, which is connected to the light emitting device, and the data line, a first capacitor connected between the first node and the second node, and a second capacitor connected between a third node of the driving transistor, which is connected to the driving voltage line, and the second node.

The above-described feature, structure, and effect of the present disclosure are included in at least one embodiment of the present disclosure, but are not limited to only one embodiment. Furthermore, the feature, structure, and effect described in at least one embodiment of the present disclosure may be implemented through combination or modification of other embodiments by those skilled in the art. Therefore, content associated with the combination and modification should be construed as being within the scope of the present disclosure.

It will be apparent to those skilled in the art that various modifications and variations can be made in the present disclosure without departing from the spirit or scope of the disclosures. Thus, it is intended that the present disclosure covers the modifications and variations of this disclosure including those of the appended claims and their equivalents.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

The various embodiments described above can be combined to provide further embodiments. Aspects of the embodiments can be modified, if necessary to employ concepts of the various embodiments to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A light emitting display apparatus comprising:
a display panel including a plurality of subpixels connected to data lines, gate lines, and driving voltage lines;
a data driving circuit configured to supply data signals to the data lines; and
a gate driving circuit configured to supply scan signals to the gate lines,
wherein each of the plurality of subpixels includes:
a light emitting device;
a driving transistor configured to connect between the driving voltage line and the light emitting device, and to control a current flowing through the light emitting device;
a first switching transistor configured to connect between a first node of the driving transistor and the data line;
a second switching transistor configured to connect between a second node of the driving transistor, which is connected to the light emitting device, and the data line;
a first capacitor connected between the first node and the second node; and
a second capacitor connected between a third node of the driving transistor, which is connected to the driving voltage line, and the second node.

2. The light emitting display apparatus of claim 1, wherein a voltage of the second node corresponds to a capacitance of the second capacitor.

3. The light emitting display apparatus of claim 2, wherein a voltage of the second node is in proportion to a capacitance of the second capacitor.

4. The light emitting display apparatus of claim 1, wherein the second node is electrically floating when the second switching transistor is turned off, and reflects an electrical characteristic of the driving transistor based on the second capacitor.

5. The light emitting display apparatus of claim 4, wherein the electrical characteristic of the driving transistor includes one or more of a threshold voltage or a mobility of the driving transistor.

6. The light emitting display apparatus of claim 1, wherein each of the plurality of subpixels is driven according to a first period, a second period, and a third period, and
wherein the data driving circuit is configured to supply a first data signal having an initialization voltage during the first period, and to supply a second data signal having a data voltage higher than the initialization voltage during the second and third periods.

7. The light emitting display apparatus of claim 6, wherein the first period is a period in which the first node and the second node are initialized to the initialization voltage,
wherein in the second period, programming of the data voltage and sampling of an electrical characteristic of the driving transistor are performed simultaneously, and
wherein in the third period, the light emitting device is driven to emit light based on the data voltage.

8. The light emitting display apparatus of claim 7, wherein the programmed data voltage is stored in the first capacitor, and
wherein a sampling voltage reflecting the electrical characteristic of the driving transistor is stored in the second node based on the second capacitor.

9. The light emitting display apparatus of claim 6, wherein the first switching transistor is controlled by a first scan signal supplied from the gate driving circuit, and
wherein the second switching transistor is controlled by a second scan signal supplied from the gate driving circuit.

10. The light emitting display apparatus of claim 9, wherein the first period starts at a timing when the first data signal is supplied, overlaps with ON states of the first and second scan signals, and ends at a timing when the second scan signal is switched to an OFF state.

11. The light emitting display apparatus of claim 10, wherein the first and second scan signals are switched to an ON state before the first period.

12. The light emitting display apparatus of claim 9, wherein the second period starts at a timing when the second data signal is supplied, overlaps with an ON state of the first scan signal, and ends at a timing when the first scan signal is switched to an OFF state.

13. The light emitting display apparatus of claim 12, wherein the second scan signal is switched to an OFF state before the second period.

14. The light emitting display apparatus of claim 9, wherein the third period starts at a timing when the first scan signal is switched to an OFF state, during the third period, the second data signal is maintained, and the third period ends at a timing when the first and second scan signals are switched to an ON state.

15. The light emitting display apparatus of claim 1, wherein the gate lines extend in a first direction,
wherein the data lines and the driving voltage lines extend in a second direction intersecting the first direction,
wherein the plurality of subpixels are arranged in the first direction or the second direction, and
wherein the driving voltage lines are disposed within the plurality of subpixels.

16. The light emitting display apparatus of claim 15, wherein the plurality of subpixels include a first subpixel, a second subpixel, a third subpixel, and a fourth subpixel, and
wherein the driving voltage line is disposed between a second data line of the second subpixel and a third data line of the third subpixel.

17. The light emitting display apparatus of claim 16, wherein the second capacitor is a dual capacitance structure or a triple capacitance structure overlapping at least a portion of the driving voltage line.

18. The light emitting display apparatus of claim 15, wherein the light emitting device includes a pixel electrode, an emission layer, and a common electrode,
wherein the light emitting device further includes a common voltage line connected to the common electrode, and
wherein the common voltage line extends in the second direction and is disposed to overlap at least a portion of the data lines.

19. The light emitting display apparatus of claim 1, wherein the display panel includes:
a substrate;
a first metal layer on the substrate;
a first insulating layer on the first metal layer;
a semiconductor layer on the first insulating layer;
a second insulating layer on the semiconductor layer;
a second metal layer on the second insulating layer;
a third insulating layer on the second metal layer; and
a third metal layer on the third insulating layer or in the third insulating layer.

20. The light emitting display apparatus of claim 19, wherein at least one of the data lines and the driving voltage lines is formed of the first metal layer,
wherein the driving transistor is formed of the semiconductor layer and the second metal layer,
wherein the first capacitor is formed of the first metal layer, the semiconductor layer included in the driving transistor, and the second metal layer included in the driving transistor, and
wherein the second capacitor is formed of the first metal layer included in the driving voltage line, the semiconductor layer overlapping the driving voltage line, and the second metal layer overlapping the driving voltage line.

21. The light emitting display apparatus of claim 20, wherein the second capacitor is electrically connected to the second node of the driving transistor through a connection line formed of the same material as the semiconductor layer.

22. The light emitting display apparatus of claim 20, further comprising a common voltage line formed of the third metal layer and overlapping at least a portion of the data lines,
wherein the second capacitor is formed of the first metal layer included in the driving voltage line, the semiconductor layer overlapping the driving voltage line, the second metal layer overlapping the driving voltage line, and the third metal layer overlapping the driving voltage line.

23. The light emitting display apparatus of claim 19, wherein the third insulating layer includes an interlayer insulating layer and a passivation layer, and
wherein the third metal layer is disposed between the interlayer insulating layer and the passivation layer.

24. A light emitting display apparatus comprising:
a display panel including a plurality of subpixels connected to data lines, gate lines, and driving voltage lines,
wherein the plurality of subpixels includes at least one first subpixel arranged along a first direction and a plurality of second subpixels arranged along a second direction intersecting the first direction,
wherein each of the plurality of subpixels comprises a light emitting device and a subpixel circuit configured to drive the light emitting device,
wherein the subpixel circuit of the at least one first subpixel arranged along the first direction comprises:
a driving transistor configured to connect between the driving voltage line and the light emitting device, and to control a current flowing through the light emitting device;
a first switching transistor configured to connect between a first node of the driving transistor and the data line;
a second switching transistor configured to connect between a second node of the driving transistor, which is connected to the light emitting device, and the data line; and
a first capacitor connected between the first node and the second node, and
wherein the subpixel circuit of each of the plurality of second subpixels arranged along the second direction comprises the driving transistor, the first switching transistor, the second switching transistor, the first capacitor, and a second capacitor connected between a third node of the driving transistor, which is connected to the driving voltage line, and the second node.

25. The light emitting display apparatus of claim 24, wherein a capacitance of the first capacitor in the subpixel circuit of the at least one first subpixel is larger than a capacitance of the first capacitor in the subpixel circuit of each of the plurality of second subpixels.

26. A pixel circuit configured to drive a light emitting device, the pixel circuit comprising:
a driving transistor configured to connect between a driving voltage line and the light emitting device, and to control a current flowing through the light emitting device;
a first switching transistor configured to connect between a first node of the driving transistor and a data line;
a second switching transistor configured to connect between a second node of the driving transistor, which is connected to the light emitting device, and the data line;
a first capacitor connected between the first node and the second node; and
a second capacitor connected between a third node of the driving transistor, which is connected to the driving voltage line, and the second node.
